(19) United States
(12) Patent Application Publication
(10) Pub. No.: US 2009/0238271 A1
(43) Pub. Date: Sep. 24, 2009

(54) APPARATUS AND METHOD FOR ENCODING AND DECODING USING ALTERNATIVE CONVERTER ACCODING TO THE CORRELATION OF RESIDUAL SIGNAL

(76) Inventors: Dae-Yeon Kim, Seoul (KR); Jeong-Il Seo, Daejon (KR); Seung-Kwon Beack, Seoul (KR); In-Seon Jang, Daejon (KR); Dae-Young Jang, Daejon (KR); Jae-Gon Kim, Daejon (KR); Kyung-Ae Moon, Daejon (KR); Jin-Woo Hong, Daejon (KR); Jin-Woong Kim, Daejon (KR); Seoung-Jun Oh, Gyeonggi-do (KR); Chang-Beom Ahn, Seoul (KR); Se-Yoon Jeong, Daejon (KR); Hae-Chul Choi, Daejon (KR); Yung-Lyul Lee, Seoul (KR); Dong-Gyu Sim, Seoul (KR); Sung-Chang Lim, Seoul (KR)

Correspondence Address: LADAS & PARRY LLP, 224 SOUTH MICHIGAN AVENUE, SUITE 1600, CHICAGO, IL, 60604, US

(21) Appl. No.: 12/441,940

(22) PCT Filed: Apr. 13, 2007
(86) PCT No.: PCT/KR07/01809

§ 371 Date: Mar. 19, 2009

(30) Foreign Application Priority Data
Sep. 20, 2006 (KR) 10-2006-0091426
Apr. 12, 2007 (KR) 10-2007-0036089

(51) Int. Cl. H04N 7/26; H04N 7/32

(52) U.S. Cl. 375/240.12; 375/240.24; 375/E07.075; 375/E07.243

(57) ABSTRACT

Provided is an apparatus and method for encoding and decoding using alternative transform units according to the correlation of residual signals. The video encoding apparatus includes a first transforming unit for performing discrete cosine transform (DCT), first quantization, first inverse quantization, and inverse DCT on a block basis onto residual coefficients generated after intra frame prediction or inter frame prediction; a second transforming unit for performing discrete sine transform (DST), second quantization, second inverse quantization, and inverse DST on a block basis onto the residual coefficients; a selecting unit for selecting one having a high compression rate between the first and second transforming units for each block through performing rate-distortion optimization; and a flag marking unit for recording information about the selected transforming unit at a flag bit provided on a macroblock basis.

### TECHNICAL FIELD

The present invention relates to an apparatus and method for encoding and decoding using alternative transform unit according to the correlation of residual signals; and, more particularly, to an encoding apparatus and method for improving a compression rate of image blocks by performing both of discrete cosine transform (DCT) and discrete sine transform (DST) and selecting one having a higher compression rate than the other between DCT and DST through performing rate-distortion optimization when a quantized transform coefficient is generated through transform and quantization after performing intra and inter prediction onto a predetermined size of block (macroblock), and a decoding apparatus and method thereof.

### BACKGROUND ART

In general, video coding is divided into intra coding for encoding frames in a picture, such as an intra frame, and inter coding for encoding frames between pictures, such as a predictive coded picture frame or a bidirectional predictive coded picture frame.

Motion estimation is performed in a unit of a block in video compression standards H.263, MPEG-4, and H.264. That is, the motion estimation is performed in a unit of a plurality of macroblocks, or the motion estimation is performed in a unit of a sub-block which is obtained by dividing a macroblock into two equal parts or four equal parts. The motion estimation is performed to reduce a bit rate by removing temporal redundancy while encoding video. Particularly, H.264 has a higher coding efficiency than the others because H.264 codes video using variable block-based motion estimation.

A motion vector is predicted with reference to past frames or with reference to both of past frames and future frames based on a time domain. A reference frame is a frame referred to encode or decode a current frame. Since H.264 supports multiple reference frames, H.264 selects a block of a frame having the most redundancy for the current block as a reference frame. Therefore, H.264 provides a higher coding efficiency than the others using only a past frame as a reference frame. Also, H.264 further improves the coding efficiency of H.264 baseline profile (BP) using a rate-distortion optimizing technology for selecting the optimal mode among a variable block mode, three space prediction modes (Intra 16×16, Intra 4×4, and IBLOCK), and a SKIP mode.

According to a H.264/MPEG-4 AVC standard for encoding/decoding video data, a transform unit is used for reducing spatial correlation of residual coefficients in a block after performing inter prediction and intra prediction and improving a compression rate and a quantizer is used for improving compression efficiency by further reducing the energy of transform coefficient after using the transform unit.

That is, the transform unit of the H.264/MPEG-4 AVC standard performs integer-approximated discrete cosine transform (DCT) on a 4×4 block basis onto residual coefficients that are generated after inter and intra prediction as shown in Eq. 1.

$$Y = {C}_{f} {XC}_{f}^{T} = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ X ] [ \begin{matrix}1 & 2 & 1 & 1 \\ 1 & 1 & - 1 & - 2 \\ 1 & - 2 & - 1 & 2 \\ 1 & - 2 & 1 & - 1\end{matrix} ] ) \qquad Eq . 1$$

In Eq. 1, Y denotes an integer-approximated discrete cosine-transformed 4×4 coefficient, and X denotes a 4×4 residual coefficient.

After performing the integer-approximated DCT through Eq. 1, a quantizer quantizes the transformed coefficient through Eq. 2, thereby generating a quantized transform coefficient.

$${Z}_{ij} = round ( {Y}_{ij} \cdot \frac{MF}{{2}^{qbits}} ) \\ qbits = 15 + floor ( \frac{QP}{6} ) \qquad Eq . 2$$

In Eq. 2, Yᵢⱼ denotes the integer-approximated discrete cosine-transformed coefficient at a position (i,j) of a 4×4 matrix and Zᵢⱼ is a quantized transform coefficient at a position (i,j) of a 4×4 matrix. QP denotes a quantization parameter and MF is a multiplication factor. Table 1 shows multiplication factors (MF) for quantization of Eq. 2 and (0,0), (1,0), . . . , (3,3) denote a position (i,j) of a 4×4 matrix.

TABLE 1

| | Position of | Position of | Other positions |
|---|---|---|---|
| QP | (0,0) (2,0) (2,2) (0,2) | (1,1) (1,3) (3,1) (3,3) | in 4 × 4 matrix |
| 0 | 13107 | 5243 | 8066 |
| 1 | 11916 | 4660 | 7490 |
| 2 | 10082 | 4194 | 6554 |
| 3 | 9362 | 3647 | 5825 |
| 4 | 8192 | 3355 | 5243 |
| 5 | 7282 | 2893 | 4559 |

The transform coefficient Zᵢⱼ is converted to a bitstream through zigzag scanning and entropy encoding and the bitstream is transmitted or stored.

On the contrary, a decoding procedure decodes a bitstream through entropy decoding, inverse quantization (inverse quantizer), and 4×4 integer-approximated discrete cosine inverse transform (inverse converter).

Hereinafter, the inverse quantization (inverse quantizer), and the 4×4 integer-approximated discrete cosine inverse transform (inverse converter) will be described.

As shown Eq. 3, the inverse quantization (inverse quantizer) is performed after entropy decoding.

$${Y}_{ij}^{′} = {Z}_{ij} \cdot {V}_{ij} \cdot {2}^{floor ( \frac{QP}{6} )} \qquad Eq . 3$$

In Eq. 3, Y′ᵢⱼ denotes the inverse transformed coefficient after inverse quantization and Vᵢⱼ denotes a scaling factor. Table 2 shows scaling factors Vᵢⱼ of the inverse quantization, and (0,0), (1,0), . . . , (3,3) denotes a position (i,j) of a 4×4 matrix.

TABLE 2

| | Position of | Position of | Other positions |
|---|---|---|---|
| QP | (0,0) (2,0) (2,2) (0,2) | (1,1) (1,3) (3,1) (3,3) | in 4 × 4 matrix |
| 0 | 10 | 16 | 13 |
| 1 | 11 | 18 | 14 |
| 2 | 13 | 20 | 16 |
| 3 | 14 | 23 | 18 |
| 4 | 16 | 25 | 20 |
| 5 | 18 | 29 | 23 |

Then, the inverse-transformed coefficient, a 4×4 matrix Y′, is expressed as a restored residual coefficient X′ through the integer-approximated discrete cosine inverse transform as shown in Eq. 4.

$$\begin{matrix}{X}^{′} = {C}_{i}^{T} {Y}^{′} {C}_{i} \\ = ( [ \begin{matrix}1 & 1 & 1 & \frac{1}{2} \\ 1 & \frac{1}{2} & - 1 & - 1 \\ 1 & - \frac{1}{2} & - 1 & 1 \\ 1 & - 1 & 1 & - \frac{1}{2}\end{matrix} ] [ {Y}^{′} ] [ \begin{matrix}1 & 1 & 1 & 1 \\ 1 & \frac{1}{2} & - \frac{1}{2} & - 1 \\ 1 & - 1 & - 1 & 1 \\ \frac{1}{2} & - 1 & 1 & - \frac{1}{2}\end{matrix} ] )\end{matrix} \qquad Eq . 4$$

Then, the restored residual coefficient X′ᵢⱼ is expressed as X″ij through post-scaling as shown in Eq. 5.

$${X}_{ij}^{″} = round ( \frac{{X}_{ij}^{′}}{64} ) \qquad Eq . 5$$

The residual coefficients are expressed as first order stationary Markov sequences having high correlativity, and the integer-approximated inverse discrete cosine transform and the inverse quantization have superior performance when the correlation coefficient value is close to 1. However, the correlation of residual coefficients in a picture has been lowered due to the development of the video encoding technology. Particularly, video encoding efficiency deteriorates if the correlation of the residual coefficients decreases.

The video encoding method according to the related art has a problem of the degradation of compression efficiency because the video encoding method according to the related art performs only quantizing a DCT coefficient in a picture when video is encoded. That is, as shown in FIG. 2, the video encoding method according to the related art performs inter frame prediction and intra frame prediction at steps S201 and S203 and performs DCT, quantization, inverse quantization, IDCT, and entropy coding at steps S202 and S204. At step S205, the video encoding method according to the related art decides a mode that minimizes, a rate-distortion cost (RDcost) among all possible encoding modes used in H.264, such as a variable block mode, three spatial prediction modes, and a SKIP mode, as an encoding mode by performing rate-distortion optimization in order to select the optimal mode. Here, the spatial prediction mode denotes an intra prediction mode, and the SKIP mode means a case not requiring encoding because a pixel value of a macroblock of a previous frame is identical to that of the current frame. The RDcost is calculated in consideration of image quality distortion and rates of each mode.

Since the video encoding method according to the related art only quantizes the DCT coefficient in a picture when the video is encoded, the video encoding efficiency of the video encoding method according to the related art deteriorates if the correlation of the residual coefficients decreases although the video encoding method according to the related art provide good video encoding efficiency when the correlation of the residual coefficients is high. Therefore, there is a demand for developing a new transforming scheme (transform unit) suitable to the low correlation of residual coefficients in order to prevent the deterioration of encoding efficiency when video is encoded.

### DISCLOSURE

### Technical Problem

An embodiment of the present invention is directed to providing an encoding apparatus and method for improving a compression rate of image blocks by performing both discrete cosine transform (DCT) and discrete sine transform (DST) and selecting one having a higher compression rate than the other between the DCT and DST through rate-distortion optimization when a quantized transformed coefficient is generated through transform and quantization after performing intra prediction and inter prediction on a predetermined size of block (macroblock), and a decoding apparatus and method thereof.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an encoding apparatus including a first transforming unit for performing discrete cosine transform (DCT), first quantization, first inverse quantization, and inverse DCT on a block basis onto residual coefficients generated after performing intra frame prediction or inter frame prediction; a second transforming unit for performing discrete sine transform (DST), second quantization, second inverse quantization, and inverse DST on a block basis onto the residual coefficients; a selecting unit for selecting one having a high compression rate between the first and second transforming unit for each block through performing rate-distortion optimization; and a flag marking unit for recording information about the selected transforming unit at a flag bit provided on a macroblock basis.

In accordance with another aspect of the present invention, there is provided a video decoding apparatus including: a flag identifying unit for detecting an encoding method of the bitstream by identifying a flag value included in a received bitstream header; and a decoding unit for performing first inverse quantization and inverse discrete cosine transform or second inverse quantization and inverse discrete sine transform according to the encoding method figured out by the flag identifying unit.

In accordance with yet another aspect of the present invention, there is provided a video encoding method including the steps of: performing discrete cosine transform (DCT), first quantization, first inverse quantization, and inverse DCT on a block basis onto residual coefficients generated after intra frame prediction or inter frame prediction; performing discrete sine transform (DST), second quantization, second inverse quantization, and inverse DST on a block basis onto the residual coefficients in addition to the step of performing DCT, first quantization, first inverse quantization, and inverse DCT; selecting a transforming scheme having a high compression rate for each a block through performing rate-distortion optimization; and recording information about the selected transforming scheme at a flag bit provided on a macroblock basis.

In accordance with still another aspect of the present invention, there is provided a video decoding method including the steps of: detecting an encoding method of the bitstream by identifying a flag value included in a header of the received bitstream; and decoding the received bitstream on a block basis by performing first inverse quantization and inverse discrete cosine transform, or second inverse quantization and inverse discrete sine transform according to the detected encoding method.

### ADVANTAGEOUS EFFECTS

An encoding/decoding apparatus and method according to the present invention can improve a compression rate by performing both DCT and DST in a transform unit and selecting one having a higher compression rate than the other between the DCT and DST through rate-distortion optimization when a quantized transform coefficient is generated through the transform unit and a quantizer after inter prediction and intra prediction are performed on a block of a predetermined size.

### BRIEF DESCRIPTION OF THE DRAWINGS

FIG. 1 illustrates a H.264/MPEG-4 AVC encoding apparatus where the present invention is applied.

FIG. 2 is a flowchart describing an encoding method for optimizing a rate-distortion optimizing structure in a H.264/MPEG-4 AVC encoding apparatus in accordance with a related art.

FIG. 3 is a block diagram illustrating an encoding apparatus selectively using transform units according to the correlation of residual coefficients in accordance with an embodiment of the present invention.

FIG. 4 is a block diagram illustrating a decoding apparatus in accordance with an embodiment of the present invention.

FIG. 5 is a flowchart describing an encoding method for optimizing a rate-distortion optimizing structure in an H.264/MPEG-4 AVC in accordance with an embodiment of the present invention.

FIGS. 6 and 7 are rate-distortion graphs for comparing an encoding/decoding method according to the present invention with the encoding/decoding method according to a related art based on “Foreman” and “Coastguard” QCIF picture.

FIGS. 8 and 9 are rate-distortion graphs for comparing an encoding/decoding method according to the present invention with the encoding/decoding method according to the related art based on “Stephen” and “HallMonitor” QCIF picture.

FIGS. 10 and 11 are rate-distortion graphs for comparing an encoding/decoding method according to the present invention with the encoding/decoding method according to the related art based on “Foreman” and “Coastguard” CIF picture.

FIGS. 12 and 13 are rate-distortion graphs for comparing an encoding/decoding method according to the present invention with the encoding/decoding method according to the related art based on “MobileandCalender” and “Soccer” QCIF picture.

### BEST MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

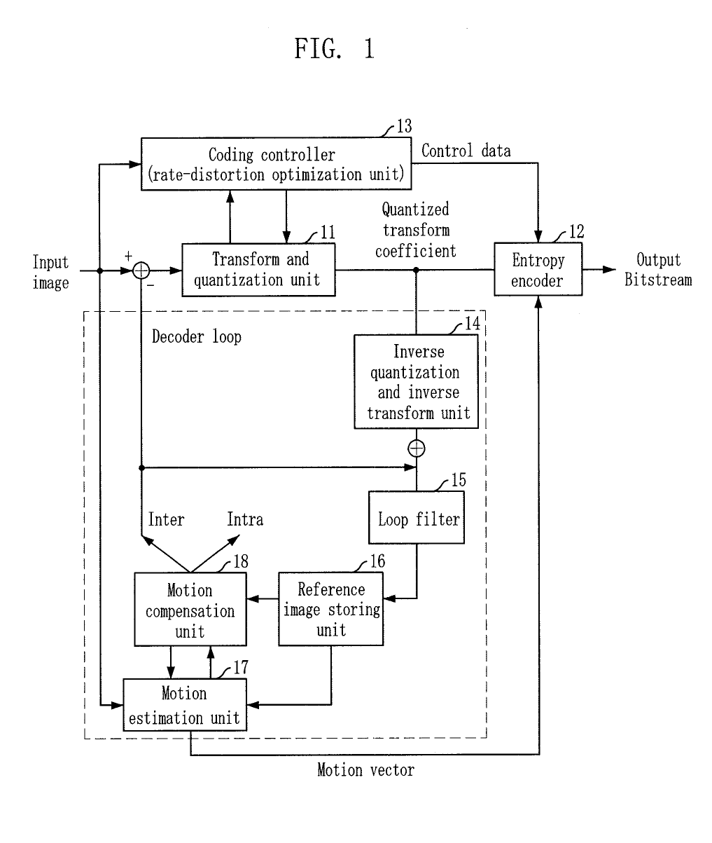

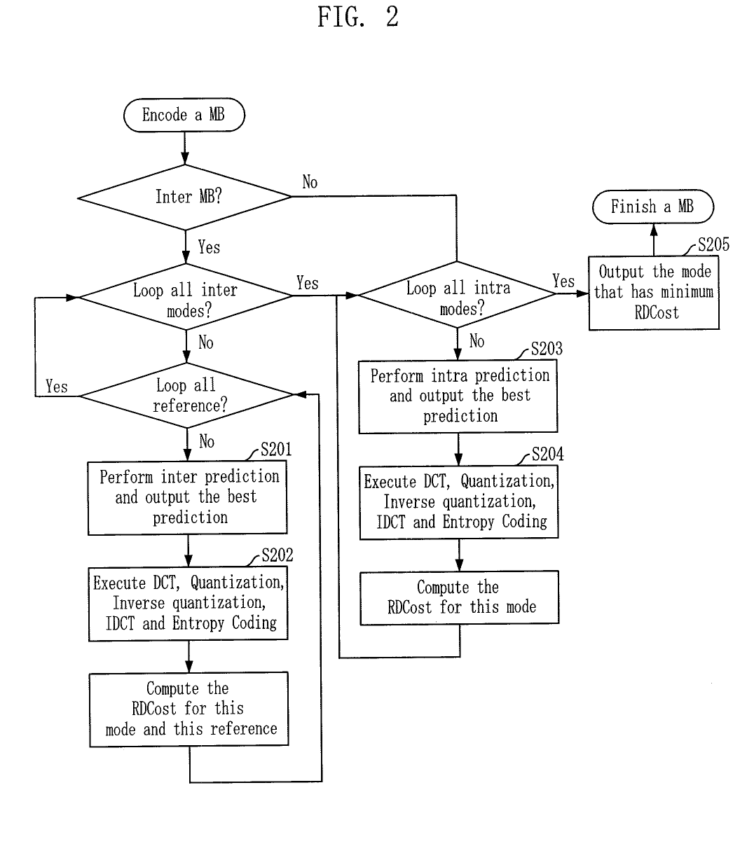

FIG. 1 illustrates a H.264/MPEG-4 AVC encoding apparatus where the present invention is applied.

The H.264/MPEG-4 AVC encoding apparatus includes a transform and quantization unit 11, an entropy encoder 12, a coding controller (rate-distortion optimizer) 13, an inverse quantization and inverse transform unit 14, a loop filter 15, a reference image storing unit 16, a motion estimation unit 17, and a motion compensation unit 18.

In general, an encoding apparatus includes a transcoder function that performs an encoding process and a decoding process, and a decoding apparatus perform a decoding process. Since the decoding process of the decoding apparatus is identical to the decoding process of the encoding apparatus, the encoding apparatus will be mainly described.

The transform and quantization unit 11 receives an input image predicted by Intra or Inter prediction. The transform and quantization unit 11 performs discrete cosine transform (DCT) and first quantization and discrete sine transform (DST) and second quantization on the received input image. The entropy encoder 12 performs entropy coding onto the transformed and quantized coefficient data and outputs a bitstream thereof. Here, the input image is also input to the coding controller 13 (rate-distortion optimization unit). The coding controller 13 decides an optimal block mode by performing inverse quantization and inverse DCT (IDCT) and inverse quantization and inverse DST (IDST) onto the input image and outputs the decided optimal block mode to the transform and quantization unit 11.

In a decoder loop, the inverse quantization and inverse transform unit 14 receives image data acquired after the DCT, first quantization, DST, and second quantization and performs first inverse quantization, IDCT, second inverse quantization, and IDST thereon. The loop filter 15 smoothes a block boundary of the inverse transformed and inverse quantized image data through low pass filtering. Then, the filtered image data is stored in the reference image storing unit 16. The motion estimation unit 17 performs motion estimation based on the stored reference image and the input image and transfers the result thereof to the motion compensation unit 18. The motion compensation unit 18 decides whether the reference image is subtracted from the input image or not according to whether a target input image to encode is an inter frame or an intra frame. Then, the motion compensation unit 18 transfers the reference image to the transform and quantization unit 11.

As described above, the encoding apparatus according to the present embodiment performs the DST process and the second quantization process and the second inverse quantization process and the IDST process for each block as well as the DCT process and the IDCT process and selects one providing a higher compression rate (DCT/IDCT or DST/IDST) than the other between the transforming processes (transform units) through rate-distortion optimization. Therefore, the encoding apparatus according to the present embodiment can improve the compression rate of an image block. That is, the encoding apparatus according to the present embodiment decides the optimal macroblock type used for motion estimation and compensation by performing rate-distortion optimization and performs the motion estimation and compensation using the decided macroblock.

Here, the encoding apparatus records the selected transform information (DCT information or DST information) at a k-bit prediction flag in a header of a macroblock layer syntax which is composed of a header field and a data field and where k is an integer number and transmits the recorded information to the decoding apparatus. Therefore, a decoding apparatus is enabled to select a decoding method based on the flag value recorded in the prediction flag.

The DST provides energy compression performance identical to optimal Karhunen Loeve transform (KL transform unit) when the correlation of residual coefficients is not large and a region of the correlation coefficient values is in (−0.5, 0.5).

In the present embodiment, transform may be performed in a N×M block as a basic block processing unit, where N and M are integer numbers. For example, transform may be performed in 4×8, 8×4, 8×8, 8×16, 16×8, and 16×16 blocks as well as 4×4 block. Hereinafter, the encoding/decoding apparatus and method according to the present embodiment will be described to perform transform in a 4×4 block as a preferred embodiment.

An encoding apparatus for selectively using transform units according to correlation of residual coefficients in accordance with an embodiment of the present invention will be described.

Since processes of performing DCT (see Eq. 1), performing the first quantization (see Eq. 2), performing the first inverse quantization (see Eq. 3), and performing the IDCT (see Eq. 4) for the residual coefficients generated after motion estimation and motion compensation are identical to those described in the background art, detail descriptions thereof are omitted.

However, the encoding apparatus according to present embodiment selects one providing a higher compression rate the other between DCT and DST by performing rate-distortion optimization in a block when a quantized transform coefficient is generated through transformation and quantization after performing inter prediction and intra prediction for a predetermined size of a block (macroblock), records information about the selected transforming scheme (DCT or DST) at a 1-bit flag bit that is added on a macroblock basis and transmits the flag bit to the decoding apparatus.

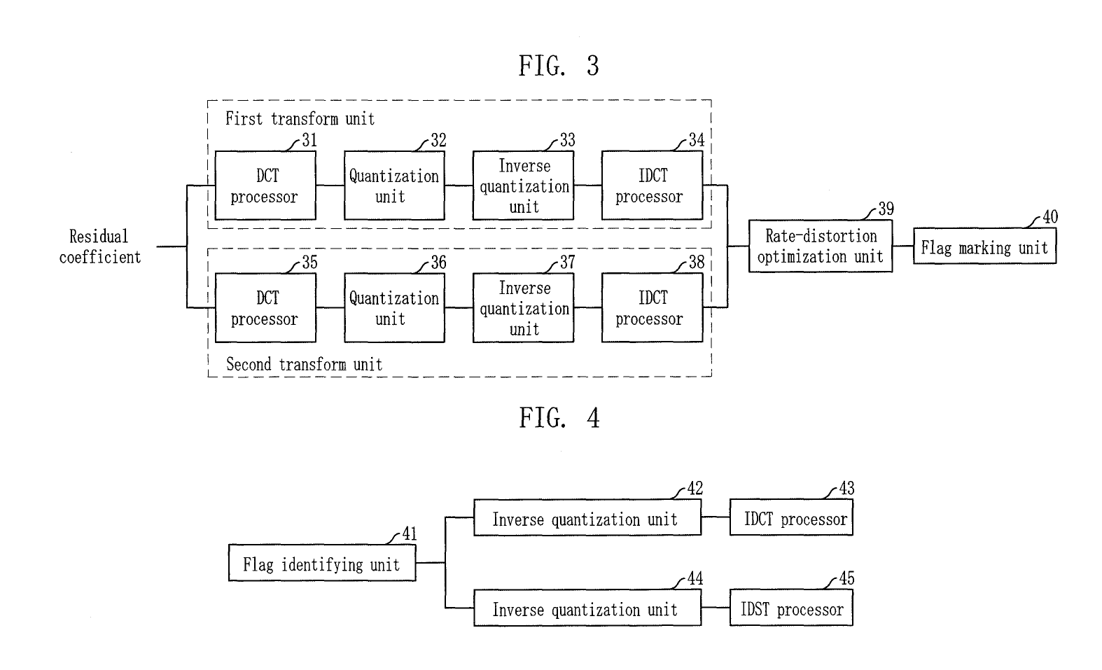

The encoding and decoding apparatus according to the present embodiment will be described in more detail with reference to FIG. 3 in detail. The encoding and decoding apparatus according to the present embodiment includes a first transform unit for performing DCT and first quantization, and first inverse quantization and IDCT on a block basis for residual coefficients that are generated after performing inter prediction and intra prediction, a second transform unit for performing DST and second quantization, and second inverse quantization and IDST on a block basis for the residual coefficients, a rate-distortion optimization unit 29 for selecting one having a higher compression rate than the other between the first transform unit and the second transform unit by performing rate-distortion optimization, and a flag marking unit 40 for recording information about the selected transform unit to a corresponding flag bit disposed on a macroblock basis.

Here, the first transform unit includes a DCT processor 31 for performing integer approximated discrete cosine transform (DCT) (integer transform) for residual coefficients (see Eq. 1), a quantization unit 32 for generating a quantized transform coefficient by performing the first quantization (referred to Eq. 2) onto the integer-transformed coefficient, an inverse quantization unit 33 for generating an integer-transformed coefficient by performing first inverse quantization (see Eq. 3) onto the quantized transform coefficient, and an IDCT processor 34 for restoring a residual coefficient by performing integer approximated inverse discrete cosine transform (see Eq. 4) onto the integer-transformed coefficient. The second transform unit includes a DST processor 35 for performing integer approximated discrete sine transform (DST) (see Eq. 8) for residual coefficients to generate integer-transformed coefficients, a quantization unit 36 for generating quantized transform coefficients by performing second quantization (referred to Eq. 10) onto the integer-transformed coefficients, an inverse quantization unit 37 for generating integer-transformed coefficients by performing second inverse quantization (referred to Eq. 11) onto the quantized transform coefficients, and an IDST processor 38 for restoring residual coefficients by performing integer approximated inverse discrete sine transform (referred to Eq. 9) onto the integer-transformed coefficients.

As described above, one of the transform units is selected according to the correlation of residual coefficients, information about the selected transform unit (DCT or DST information) is recorded at a 1-bit flag bit, and the flag bit is transmitted to a decoding apparatus of FIG. 4.

The decoding apparatus of FIG. 4 identifies the information about the selected transform unit through a flag identifying unit 41 and performs inverse quantization and IDCT onto a received bitstream on a block basis through an inverse quantization unit 44 and an IDST processor 45 or performs inverse quantization and IDST through an inverse quantization unit 44 and an IDST processor 45, thereby performing decode with a suitable block unit.

The decoding apparatus includes a flag identifying unit 41 for identifying a flag value included in a header of a received bitstream and detecting a coding method of the received bitstream based on the identified flag value and a decoding unit for decoding a bitstream on a block basis through inverse quantization and IDCT or inverse quantization and IDST. The decoding unit includes an inverse quantization unit 42, an IDCT processor 43, an inverse quantization unit 44, and an IDST processor 45.

Here, a flag value included in a bitstream header indicates the selected one of the first transform unit and the second transform unit, which provides the higher compression efficiency. As described above with reference to FIG. 3, the first transform unit performs the DCT (see Eq. 1), the first quantization (see Eq. 2), the first inverse quantization (see Eq. 3), and the IDCT (see Eq. 4) on a block basis onto residual coefficients generated after inter prediction and intra prediction. The second transform unit performs the DST (Eq. 8), the second quantization (Eq. 10), the second inverse quantization (Eq. 11), and the IDST (Eq. 9) on a block basis for residual coefficients.

Hereinafter, the operation of the encoding apparatus for selectively using transform units according to the correlation of residual coefficients according to the present embodiment will be described in detail.

At first, Eq. 6 and Eq. 7 express the first order discrete sine transform (DST) and the first order inverse discrete sine transform (IDST).

$$\begin{matrix}Y ( k ) = \sqrt{\frac{2}{N + 1}} {\sum }_{n = 0}^{N - 1} X ( n ) sin \frac{π ( k + 1 ) ( n + 1 )}{N + 1} , \\ 0 \leq k \leq N - 1 & Eq . 6 \\ X ( n ) = \sqrt{\frac{2}{N + 1}} {\sum }_{k = 0}^{N - 1} Y ( k ) sin \frac{π ( k + 1 ) ( n + 1 )}{N + 1} , \\ 0 \leq n \leq N - 1 & Eq . 7\end{matrix}$$

In Eq. 6 and Eq. 7, X denotes a residual coefficient to be processed through DST, Y is a DST processed coefficient, and N denotes a unit side of DST.

In order to use Eq. 6 and Eq. 7 in a video coding apparatus, Eq. 6 and Eq. 7 are converted to a 4×4 discrete sine transform matrix and an inverse discrete sine transform matrix as shown in Eq. 8 and Eq. 9.

$$\begin{matrix}\begin{matrix}Y = {CXC}^{T} \\ = ( [ \begin{matrix}a & b & b & a \\ b & a & - a & - b \\ b & - a & - a & b \\ a & - b & b & - a\end{matrix} ] [ X ] [ \begin{matrix}a & b & b & a \\ b & a & - a & - b \\ b & - a & - a & b \\ a & - b & b & - a\end{matrix} ] )\end{matrix} & Eq . 8 \\ \begin{matrix}{X}^{′} = {C}^{T} YC \\ = ( [ \begin{matrix}a & b & b & a \\ b & a & - a & - b \\ b & - a & - a & b \\ a & - b & b & - a\end{matrix} ] [ {Y}^{′} ] [ \begin{matrix}a & b & b & a \\ b & a & - a & - b \\ b & - a & - a & b \\ a & - b & b & - a\end{matrix} ] )\end{matrix} & Eq . 9\end{matrix}$$

In Eq. 8, C denotes a DST matrix for each row of X and C^{T} denotes a DST matrix transposed for each column of X. In Eq. 9, C and C^{T} are identical to those in Eq. 8. Also, X′ denotes a restored residual coefficient and Y′ denotes an inverse-quantized transform coefficient. Elements a and b in the matrix denote constants \sqrt{⅖}sin(π/5) and \sqrt{⅖}sin(⅖π).

Therefore, the DST is performed by the DST processor 35 on a 4×4 block basis for the residual coefficient generated after inter prediction and intra prediction as shown in Eq. 8 as a method of a H.264/MPEG-4 AVC transform unit.

After performing the DST through Eq. 8, the discrete sine-transformed coefficient is quantized through the second quantization process of Eq. 10 by the quantization unit 36, thereby generating a quantized DST coefficient.

$${Z}_{ij} = round ( \frac{{Y}_{ij}}{QStep} + 0.5 ) \qquad Eq . 10$$

In Eq. 10, Zᵢⱼ denotes a quantized DST coefficient located at a position (i,j) of a matrix. QStep denotes a step size of a quantization unit, and round ( ) denotes a rounding off function.

On the contrary, the transformed bitstream is processed through inverse quantization using an inverse quantization unit 37 and 4×4 IDST using an IDST processor 38 in a decoding procedure. Hereinafter, the operations of the inverse quantization unit 37 and the IDST processor 38 will be described.

At first, the inverse quantization unit 37 performs inverse quantization onto the quantized DST coefficient as shown in Eq. 11.

Y′ᵢⱼ=Zᵢⱼ·QStep Eq. 11

Then, the DST coefficient 4×4 matrix Y′ is converted to a 4×4 restored residual coefficient X′ through IDST by the IDST processor 38 as shown in Eq. 9.

Then, the restored residual coefficient X′ᵢⱼ is transformed to X″ᵢⱼ through rounding off as shown in Eq. 12.

X″ᵢⱼ=round(X′ᵢⱼ+0.5) Eq. 12

In Eq. 12, X*ᵢⱼ denotes a final restored residual coefficient of a 4×4 block.

As described above, the DST, the second quantization, the second inverse quantization, and the IDST are completely performed.

As described above, the information about a transform unit (DCT or DST) selected according to the correlation of residual signals by the encoding apparatus is recorded in a 1-bit flag bit which is added on a macroblock basis. Then, the flag bit is transmitted to the decoding apparatus of FIG. 4. Therefore, the decoding apparatus is enabled to decode the bitstream with a proper method. Here, the flag bit having information about the selected transform unit may be applied to various unit blocks such as the maximum N×N unit block to minimum 4×4 unit block.

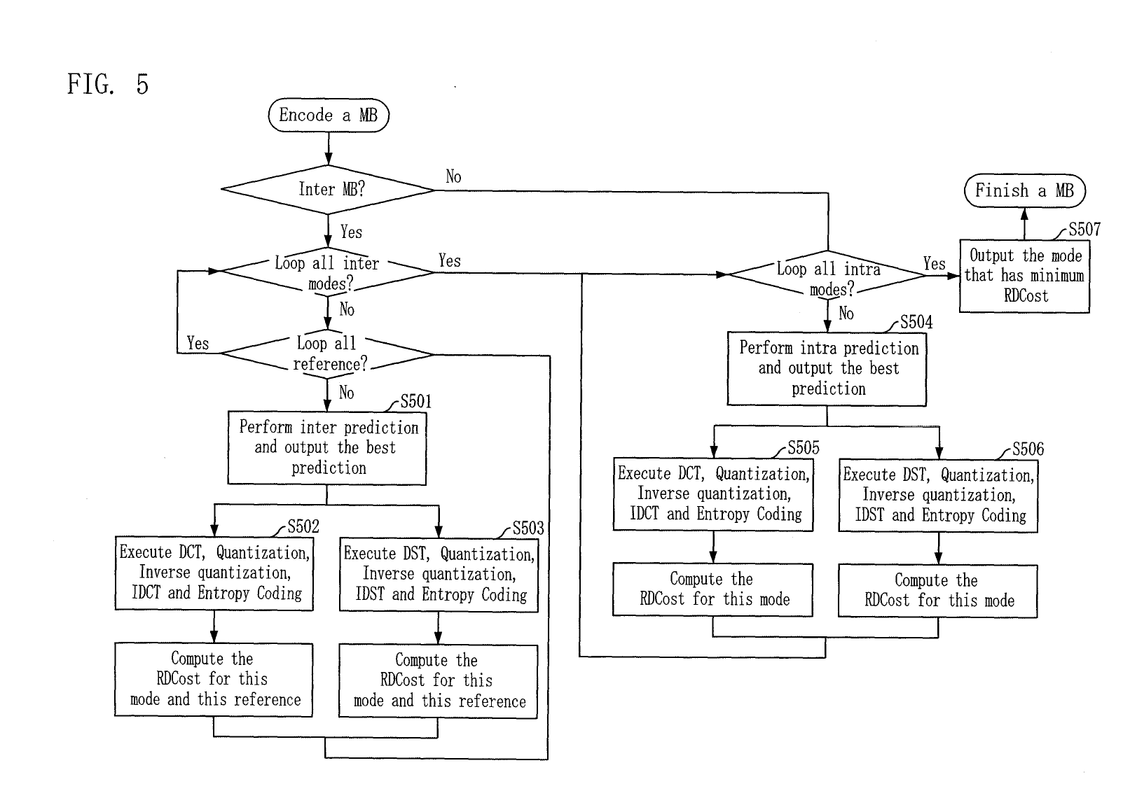

Therefore, a compression rate can be improved by selecting a transform unit by modifying the structure of rate-distortion optimization in the H.264/MPEG-4 AVC encoding apparatus according to the related art to that shown in FIG. 5.

As shown in FIG. 5, intra frame prediction and inter frame prediction are performed at steps S501 and 504. Then, integer approximated discrete cosine transform (DCT), first quantization, first inverse quantization, and integer approximated inverse DCT, and entropy encoding are performed at steps S505 and S506. Then, a mode that minimizes a rate-distortion cost (RDcost) is selected from all possible coding modes used in H.264, such as a variable block mode, three spatial prediction modes, and a SKIP mode at step S507. That is, a transform unit having high compression efficiency is selected. The information about the selected transform unit is recorded at a corresponding flag bit disposed on a macroblock basis and transmitted to the decoding apparatus. Therefore, the decoding apparatus is enabled to decide a proper decoding method using the flag value recorded in the prediction flag.

Hereinafter, the performance of the encoding/decoding apparatus and method for selectively using transform units according to the correlation of residual coefficients according to the present embodiment will be described using results of simulations with various images.

The simulations were performed using a joint model (JM) 10.2 encoder that supports H.264/MPEG-4 AVC. As test images, four 176×144 quarter common intermediate format (QCIF) images and four 352×288 common intermediate format (CIF) images, which are stored at 30 Hz frame rate. Table 3 shows simulation conditions.

TABLE 3

| | |
|---|---|
| GOP Structure | IPPP |
| Intra Period | Every 10^{th} frame |
| QP | 4, 8, 12, 16, 20 |
| Search Range | 16 |
| Multiple Reference Frames | 5 |
| Rate Control | Off |
| Entropy Coding Method | CABAC |
| Rate-Distortion Optimization | On |

Table 4 shows compression rates obtained from simulations performed under the conditions of Table 3. In the simulations, various images were compressed using the H.264/MPEG-4 AVC compressing method according to the related art and the encoding method according to the present embodiment.

TABLE 4

| Sequence | | H.264/MPEG-4 AVC | | Proposed | |
|---|---|---|---|---|---|
| (Frame Size) | QP | PSNR (dB) | Bitrates (kbps) | PSNR (dB) | Bitrates (kbps) |
| Foreman | 4 | 55.3 | 3043.87 | 59.62 | 3271.49 |
| (QCIF) | 8 | 51.53 | 2114.2 | 53.58 | 2364.48 |
| | 12 | 48.33 | 1393.4 | 49.34 | 1541.8 |
| | 16 | 45.15 | 886.9 | 45.46 | 929.32 |
| | 20 | 41.9 | 522.63 | 42.02 | 538.05 |
| Coastguard | 4 | 55.1 | 3169.25 | 59.46 | 3328.65 |
| (QCIF) | 8 | 51.34 | 2302.34 | 53.66 | 2505.6 |
| | 12 | 47.98 | 1643.49 | 49.78 | 1834.33 |
| | 16 | 44.6 | 1148.25 | 45.55 | 1254.72 |
| | 20 | 41 | 728.49 | 41.35 | 771.53 |
| Stephen | 4 | 55.3 | 4164.19 | 59.59 | 4361.34 |
| (QCIF) | 8 | 51.48 | 3142.25 | 53.47 | 3286.71 |
| | 12 | 48.22 | 2313.47 | 50.1 | 2467.89 |
| | 16 | 45.03 | 1674.74 | 46.65 | 1804.36 |
| | 20 | 41.49 | 1143.88 | 42.75 | 1253.44 |
| Hall Monitor | 4 | 55.71 | 3142.06 | 60.2 | 3374.17 |
| (QCIF) | 8 | 51.79 | 2152.75 | 53.9 | 2465.09 |
| | 12 | 48.6 | 1339.04 | 49.19 | 1448.67 |
| | 16 | 45.56 | 703.72 | 45.72 | 729.12 |
| | 20 | 42.86 | 321.03 | 42.94 | 330.41 |
| Foreman | 4 | 55.51 | 12031.04 | 59.93 | 12817.17 |
| (CIF) | 8 | 51.6 | 8289.02 | 53.68 | 9282.72 |
| | 12 | 48.4 | 5364.61 | 49.67 | 6139.58 |
| | 16 | 45.27 | 3265.86 | 45.57 | 3450.44 |
| | 20 | 42.09 | 1763.34 | 42.17 | 1807.56 |
| Coastguard | 4 | 55.32 | 14018.72 | 59.69 | 14592.86 |
| (CIF) | 8 | 51.41 | 10133.77 | 53.79 | 10932.77 |
| | 12 | 48.03 | 7176.87 | 50.25 | 8146.38 |
| | 16 | 44.73 | 5043.05 | 45.94 | 5587.2 |
| | 20 | 41.17 | 3216.08 | 41.76 | 3499.68 |
| Mobile and Calender | 4 | 55.13 | 13908.67 | 59.43 | 14391.59 |
| (CIF) | 8 | 51.32 | 10084.17 | 53.64 | 10943.29 |
| | 12 | 47.97 | 7194.18 | 50.09 | 8112.2 |
| | 16 | 44.67 | 4922.61 | 46.12 | 5458.25 |
| | 20 | 41.06 | 3023.8 | 42 | 3259.43 |
| Soccer | 4 | 55.67 | 13908.67 | 60.07 | 14391.59 |
| (CIF) | 8 | 51.53 | 10084.17 | 53.83 | 10943.29 |
| | 12 | 48.16 | 7194.18 | 50.03 | 8112.2 |
| | 16 | 44.87 | 4922.61 | 45.84 | 5458.25 |
| | 20 | 41.42 | 3023.8 | 41.83 | 3259.43 |

Table 4 clearly shows that the performance of the encoding method selectively using the transform unit according to the correlation of residual coefficients according to the present embodiment is much better than the H.264/MPEG-4 AVC compression method.

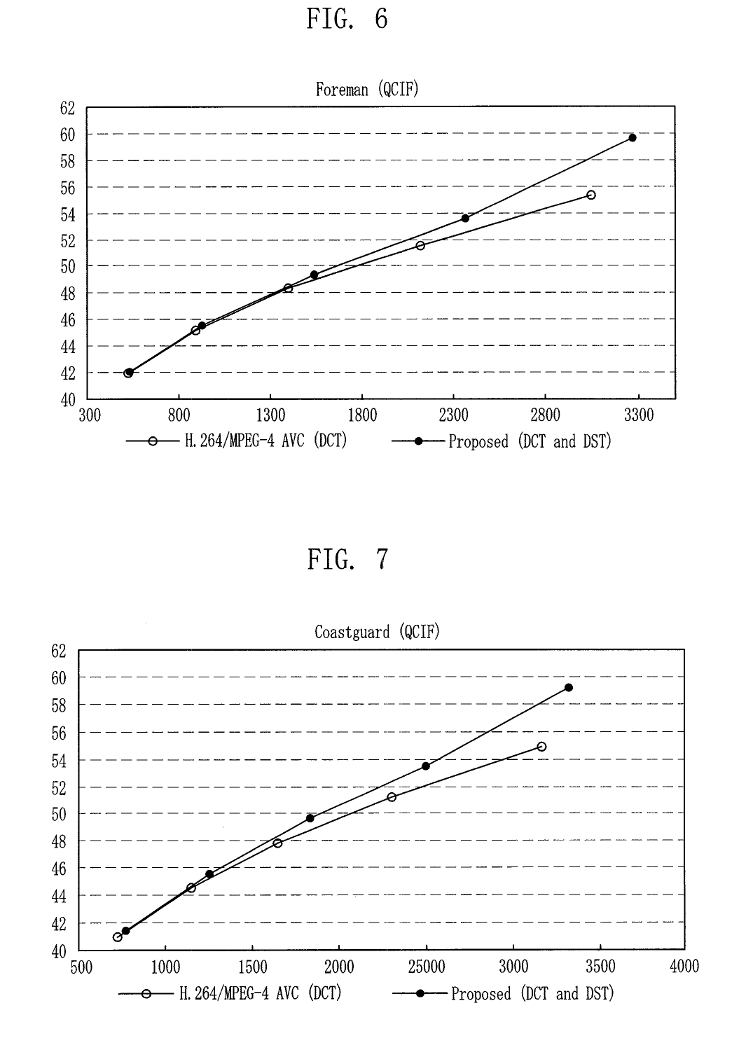

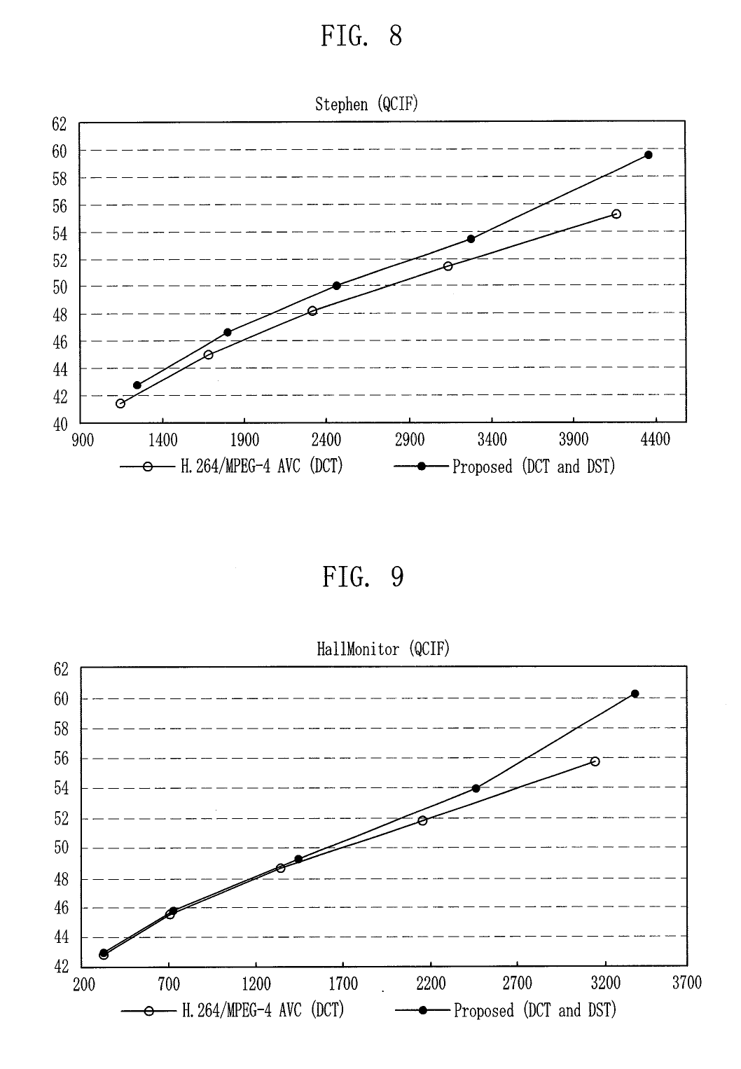

FIGS. 6, 7, 8, and 9 are rate-distortion graphs of QCIF pictures used in Table 4 for comparing an encoding/decoding method (apparatus) according to the present invention with the encoding/decoding method according to the related art.

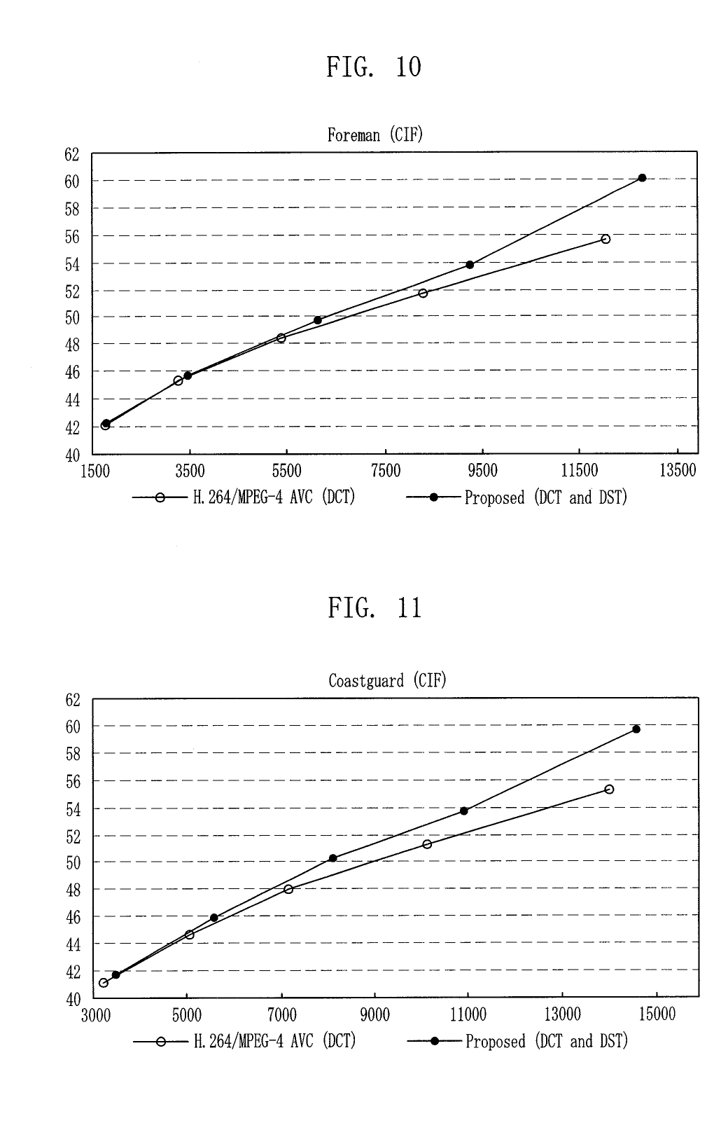

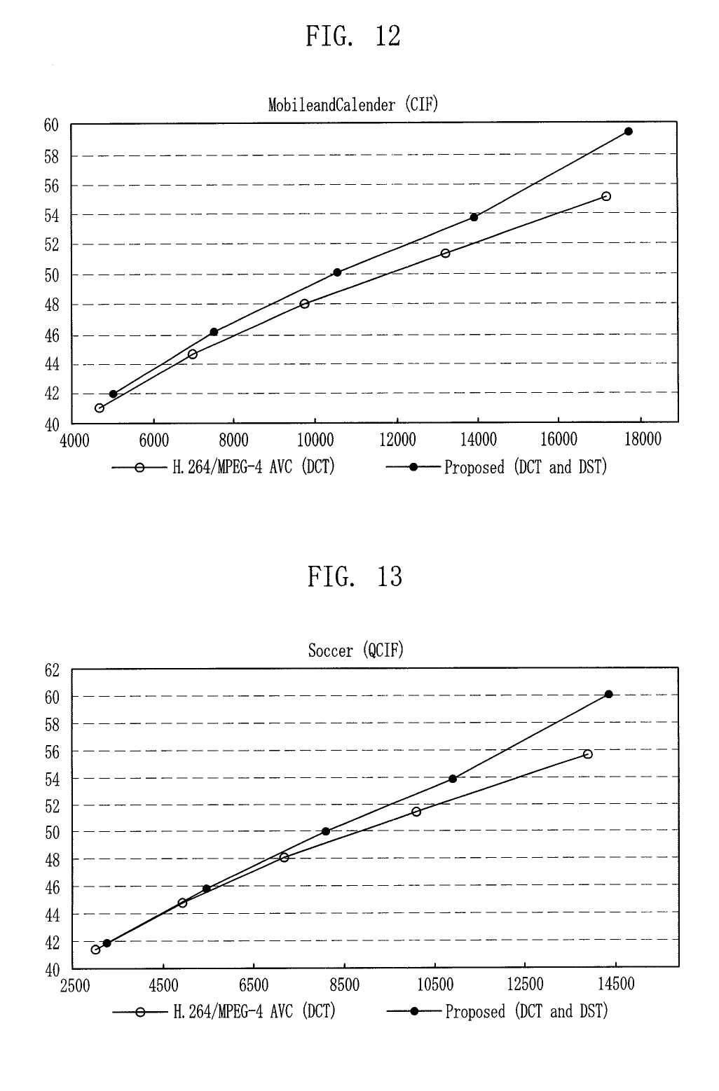

FIGS. 10, 11, 12 and 13 are rate-distortion graphs of CIF pictures used in Table 4 for comparing an encoding/decoding method (apparatus) according to the present invention with the encoding/decoding method according to the related art.

The rate-distortion graphs also clearly shows that the performance of the encoding method selectively using the transform unit according to the correlation of residual coefficients according to the present embodiment is improved as much as maximum 3 db compared to the H.264/MPEG-4 AVC compression method.

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media.

While the present invention has been described with respect to certain preferred embodiments, it will be apparent to those skilled in the art that various changes and modifications may be made without departing from the scope of the invention as defined in the following claims.

What is claimed is:

1. A video encoding apparatus, comprising:
a first transforming means for performing discrete cosine transform (DCT), first quantization, first inverse quantization, and inverse DCT (IDCT) on a block basis onto residual coefficients that are generated after intra frame prediction or inter frame prediction;
a second transforming means for performing discrete sine transform (DST), second quantization, second inverse quantization, and inverse DST (IDST) onto the residual coefficients on a block basis;
a selecting means for selecting a transforming means having a high compression rate for each block by performing rate-distortion optimization; and
a flag marking means for recording information about the selected transforming means at a flag bit provided on a macroblock basis.

2. The video encoding apparatus of claim 1, wherein the block is an N×M block, where N and M are integer numbers.

3. The video encoding apparatus of claim 1, wherein the information about the selected transforming means is recorded at the flag bit in a macroblock layer header of bitstream.

4. The video encoding apparatus of claim 3, wherein the selecting means selects the first transforming means when correlation of the residual coefficients is high and selects the second transforming means when the correlativity of the residual coefficients is low.

5. The video encoding apparatus of claim 4, wherein the first transforming means includes:
a DCT means for performing integer-approximated DCT onto the residual coefficients to thereby generate integer-transformed coefficients;
a quantization means for performing first quantization onto the integer-transformed coefficients acquired in the DCT means generating quantized integer-transformed coefficients;
an inverse quantization means for performing first inverse quantization onto the quantized integer-transformed coefficients acquired in the quantization means to thereby generate integer-transformed coefficients; and
an inverse discrete cosine transform (IDCT) means for restoring the residual coefficients by performing integer-approximated IDCT onto the integer-transformed coefficients acquired in the inverse quantization means.

6. The video encoding apparatus of claim 4, wherein the second transforming means includes:
a discrete sine transform (DST) means for performing DST onto the residual coefficients to thereby generate discrete sine-transformed coefficients;
a quantization means for performing second quantization onto the discrete sine-transformed coefficients acquired in the DST means to thereby generate quantized DST coefficients;
an inverse quantization means for performing second inverse quantization onto the quantized DST coefficients acquired in the quantization means to thereby generate discrete sine-transformed coefficients; and
an inverse discrete sine transform (IDST) means for restoring residual coefficients by performing IDST onto the discrete sine-transformed coefficients acquired in the inverse quantization means.

7. The video encoding apparatus of claim 6, wherein the second transforming means has optimal compression performance when a region of correlation coefficient values is (−0.5, 0.5).

8. The video encoding apparatus of claim 6, wherein the DST means performs DST onto residual coefficients generated after intra frame prediction and inter frame prediction on a 4×4 block basis using an equation 1:
$$\begin{matrix}Y = {CXC}^{T} \\ = ( [ \begin{matrix}a & b & b & a \\ b & a & - a & - b \\ b & - a & - a & b \\ a & - b & b & - a\end{matrix} ] [ X ] [ \begin{matrix}a & b & b & a \\ b & a & - a & - b \\ b & - a & - a & b \\ a & - b & b & - a\end{matrix} ] )\end{matrix} \qquad Eq . 1$$
where X denotes a residual coefficient to be discrete sine-transformed;
C denotes a DST matrix for each row of X; and
C^{T} denotes a DST matrix transposed for each column of X.

9. The video encoding apparatus of claim 8, wherein the quantization means generates quantized DST coefficients by performing second quantization onto the discrete sine-transformed coefficients using an equation 2:
$${Z}_{ij} = round ( \frac{{Y}_{ij}}{QStep} + 0.5 ) \qquad Eq . 2$$
where Zᵢⱼ denotes a quantized discrete sine-transformed coefficient located at a position (i,j) of a matrix; QStep denotes a step size of a quantization unit; and
round ( ) denotes a rounding off function.

10. The video encoding apparatus of claim 9, wherein the inverse quantization means performs second inverse quantization onto quantized DST coefficients using an equation 3:
Y′ᵢⱼ=Zᵢⱼ·QStep Eq. 3
where Y′ᵢⱼ is an integer-transformed coefficient after inverse quantization.

11. The encoding apparatus of claim 10, wherein the IDST means generates a restored residual coefficient X′ of a 4×4 matrix by performing IDST onto a discrete sine-transformed coefficient 4×4 matrix Y′ based on an equation 4:
$$\begin{matrix}{X}^{′} = {C}^{T} YC \\ = ( [ \begin{matrix}a & b & b & a \\ b & a & - a & - b \\ b & - a & - a & b \\ a & - b & b & - a\end{matrix} ] [ {Y}^{′} ] [ \begin{matrix}a & b & b & a \\ b & a & - a & - b \\ b & - a & - a & b \\ a & - b & b & - a\end{matrix} ] )\end{matrix} \qquad Eq . 4$$
where C denotes a DST matrix for each row of X;
C^{T} denotes a DST matrix transposed for each column of X;
X′ denotes a restored residual coefficient;
Y′ denotes an inverse-quantized transformed coefficient; and
elements a and b in the matrix denote constants
$$\sqrt{\frac{2}{5}} sin ( \frac{π}{5} ) and \sqrt{\frac{2}{5}} sin ( \frac{2}{5} π ) ,$$
respectively.

12. The video encoding apparatus of claim 11, wherein X″ᵢⱼ is generated by rounding off the restored residual coefficient X′ᵢⱼ using an equation 5:
X″ᵢⱼ=round(X′ᵢⱼ+0.5) Eq. 5
where X″ᵢⱼ is a finally restored residual coefficient of a 4×4 unit block.

13. The video encoding apparatus of claim 3, wherein the encoding apparatus performs a transcoder function including an encoding function and a decoding function.

14. A video decoding apparatus, comprising:
a flag identifying means for detecting an encoding method of a received bitstream by identifying a flag value included in a header of the received bitstream; and
a decoding means for decoding the received bitstream on a block basis by performing first inverse quantization and inverse discrete cosine transform, or second inverse quantization and inverse discrete sine transform according to the encoding method found out by the flag identifying means.

15. The video decoding apparatus of claim 14, wherein the flag value is inserted by an encoding apparatus into a flag bit provided on a macroblock basis, and the flag value corresponds to a transforming scheme having a high compression rate for each block by performing rate-distortion optimization between a first transforming scheme and a second transforming scheme, where the first transforming scheme is to perform discrete cosine transform (DCT), first quantization, first inverse quantization, and inverse DCT on the basis of a block onto residual coefficients generated after inter prediction and intra prediction, and the second transforming scheme is to perform discrete sine transform (DST), second quantization, second inverse quantization, and inverse DST onto the residual coefficients on a block basis.

16. The video decoding apparatus of claim 15, wherein the decoding means performs the second quantization onto quantized DST coefficients using an equation 1 expressed as:
Y′ᵢⱼ=Zᵢⱼ·QStep Eq. 1
where Y′ᵢⱼ is an integer-transformed coefficient after inverse quantization.

17. The video decoding apparatus of claim 16, wherein the decoding means generates a restored residual coefficient X′ of a 4×4 matrix by performing IDST onto a discrete sine-transformed coefficient 4×4 matrix Y′ using an equation 2:
$$\begin{matrix}{X}^{′} = {C}^{T} YC \\ = ( [ \begin{matrix}a & b & b & a \\ b & a & - a & - b \\ b & - a & - a & b \\ a & - b & b & - a\end{matrix} ] [ {Y}^{′} ] [ \begin{matrix}a & b & b & a \\ b & a & - a & - b \\ b & - a & - a & b \\ a & - b & b & - a\end{matrix} ] )\end{matrix} \qquad Eq . 2$$
where C denotes a DST matrix for each row of X;
C^{T} denotes a DST matrix transposed for each column of X;
X′ denotes a restored residual coefficient;
Y′ denotes an inverse-quantized transform coefficient; and
elements a and b in the matrix denote constants
$$\sqrt{\frac{2}{5}} sin ( \frac{π}{5} ) and \sqrt{\frac{2}{5}} sin ( \frac{2}{5} π ) ,$$
respectively.

18. The decoding apparatus of claim 17, wherein X″ᵢⱼ is generated by rounding off the restored residual coefficient X′ᵢⱼ using an equation 3:
X″ᵢⱼ=round(X′ᵢⱼ+0.5) Eq. 3
where X″ᵢⱼ is a final restored residual coefficient of a 4×4 unit block.

19. A video encoding method, comprising the steps of:
performing discrete cosine transform (DCT), first quantization, first inverse quantization, and inverse DCT on a block basis onto residual coefficients generated after intra frame prediction or inter frame prediction;
performing discrete sine transform (DST), second quantization, second inverse quantization, and inverse DST on a block basis onto the residual coefficients in addition to the step of performing DCT, first quantization, first inverse quantization, and inverse DCT;
selecting a transforming scheme having a high compression rate for each block by performing rate-distortion optimization; and
compressing a video on a block basis by recording information about the selected transforming scheme at a flag bit provided on a macroblock basis.

20. The video encoding method of claim 19, wherein the block is an N×M block, where N and M are integer numbers.

21. The video encoding method of claim 19, wherein the information about the selected transforming scheme is recorded at the flag bit in a macroblock layer header of bitstream.

22. The video encoding method of claim 21, wherein the step of performing DCT, first quantization, first inverse quantization, and inverse DCT on a block basis includes the steps of:
performing integer-approximated DCT onto the residual coefficients to thereby generate integer-transformed coefficients;
performing first quantization onto the integer-transformed coefficients to thereby generate quantized integer-transformed coefficients;
performing first inverse quantization onto the quantized integer-transformed coefficients to thereby generate integer-transformed coefficients; and
restoring residual coefficients by performing integer-approximated inverse discrete cosine transform (IDCT) onto the integer-transformed coefficients acquired from the step of performing first inverse quantization to perform integer inverse transform.

23. The video encoding method of claim 21, wherein the step of performing DST, second quantization, second inverse quantization, and IDST includes the steps of:
performing DST onto the residual coefficients to thereby generate discrete sine-transformed coefficients;
performing second quantization onto the discrete sine-transformed coefficients to thereby generate quantized DST coefficients;
performing second inverse quantization onto the quantized DST coefficients to generate discrete sine-transformed coefficients; and
restoring residual coefficients by performing IDST onto the discrete sine-transformed coefficients acquired from the step of performing second inverse quantization.

24. The video decoding apparatus of claim 23, wherein the step of performing IDST, DST is performed onto residual coefficients generated after intra frame prediction and inter frame prediction on a 4×4 block basis using an equation 1:
$$\begin{matrix}Y = {CXC}^{T} \\ = ( [ \begin{matrix}a & b & b & a \\ b & a & - a & - b \\ b & - a & - a & b \\ a & - b & b & - a\end{matrix} ] [ X ] [ \begin{matrix}a & b & b & a \\ b & a & - a & - b \\ b & - a & - a & b \\ a & - b & b & - a\end{matrix} ] )\end{matrix} \qquad Eq . 1$$
where X denotes a residual coefficient to be discrete sine-transformed;
C denotes a DST matrix for each row of X; and
C^{T} denotes a DST matrix transposed for each column of X.

25. The video encoding method of claim 24, wherein in the step of performing second quantization, quantized DST coefficients are generated by quantizing the discrete sine-transformed coefficients using an equation 2 expressed as:
$${Z}_{ij} = round ( \frac{{Y}_{ij}}{QStep} + 0.5 ) \qquad Eq . 2$$
where Zᵢⱼ denotes a quantized discrete sine-transformed coefficient located at a position (i,j) of a matrix; QStep denotes a step size of a quantization unit; and round ( ) denotes a rounding off function.

26. The video encoding method of claim 25, wherein in the step of performing second inverse quantization onto the quantized DST coefficients, inverse quantization is performed onto the quantized DST coefficients using an equation 3 expressed as:
Y′ᵢⱼ=Zᵢⱼ·QStep Eq. 3
where Y′ᵢⱼ is an integer-transformed coefficient after inverse quantization.

27. The video encoding method of claim 26, wherein in the step of restoring residual coefficients, a restored residual coefficient X′ of a 4×4 matrix is generated by performing IDST onto a discrete sine-transformed coefficient 4×4 matrix Y′ based on an equation 4:
$$\begin{matrix}{X}^{′} = {C}^{T} YC \\ = ( [ \begin{matrix}a & b & b & a \\ b & a & - a & - b \\ b & - a & - a & b \\ a & - b & b & - a\end{matrix} ] [ {Y}^{′} ] [ \begin{matrix}a & b & b & a \\ b & a & - a & - b \\ b & - a & - a & b \\ a & - b & b & - a\end{matrix} ] )\end{matrix} \qquad Eq . 4$$
where C denotes a DST matrix for each row of X;
C^{T} denotes a DST matrix transposed for each column of X;
X′ denotes a restored residual coefficient;
Y′ denotes an inverse-quantized transform coefficient; and elements a and b in the matrix denote constants
$$\sqrt{\frac{2}{5}} sin ( \frac{π}{5} ) and \sqrt{\frac{2}{5}} sin ( \frac{2}{5} π ) ,$$
respectively.

28. The video encoding method of claim 27, wherein in the step of restoring residual coefficients, X″ᵢⱼ is generated by rounding off the restored residual coefficient X′ᵢⱼ using an equation 5:
X′ᵢⱼ=round(X′ᵢⱼ+0.5) Eq. 5
where X″ᵢⱼ is a finally restored residual coefficient of a 4×4 unit block.

29. A video decoding method, comprising the steps of:
detecting an encoding method of a received bitstream by identifying a flag value included in a header of the received bitstream; and
decoding the received bitstream on a block basis by performing first inverse quantization and inverse discrete cosine transform (IDCT), or second inverse quantization and inverse discrete sine transform (IDST) according to the encoding method.

30. The video decoding method of claim 29, wherein the flag value is inserted into a flag bit provided on a macroblock basis, and the flag value indicates a transforming scheme having a high compression rate by performing rate-distortion optimization for each block between a first transforming scheme and a second transforming, where the first transforming scheme performs DCT, first quantization, first inverse quantization, and inverse DCT onto residual coefficients generated after inter prediction and intra prediction on a block basis, and the second transforming scheme performs DST, second quantization, second inverse quantization, and inverse DST onto the residual coefficients on a block basis.

31. The video decoding method of claim 30, wherein in the step of performing first inverse quantization and IDCT or second inverse quantization and IDST, the second quantization is performed onto quantized DST coefficients using an equation 1:
Y′ᵢⱼ=Zᵢⱼ·QStep Eq. 1
where Y′ᵢⱼ is an integer-transformed coefficient after inverse quantization.

32. The video decoding apparatus of claim 31, wherein in the step of performing first inverse quantization and IDCT or second inverse quantization and IDST, a restored residual coefficient X′ of a 4×4 matrix is generated by performing IDST onto a discrete sine-transformed coefficient 4×4 matrix Y′ using an equation 2:
$$\begin{matrix}{X}^{′} = {C}^{T} YC \\ = ( [ \begin{matrix}a & b & b & a \\ b & a & - a & - b \\ b & - a & - a & b \\ a & - b & b & - a\end{matrix} ] [ {Y}^{′} ] [ \begin{matrix}a & b & b & a \\ b & a & - a & - b \\ b & - a & - a & b \\ a & - b & b & - a\end{matrix} ] )\end{matrix} \qquad Eq . 2$$
where C denotes a DST matrix for each row of X;
C^{T} denotes a DST matrix transposed for each column of X;
X′ denotes a restored residual coefficient;
Y′ denotes an inverse-quantized transform coefficient; and
elements a and b in the matrix denote constants
$$\sqrt{\frac{2}{5}} sin ( \frac{π}{5} ) and \sqrt{\frac{2}{5}} sin ( \frac{2}{5} π ) ,$$
respectively.

33. The video decoding method of claim 32, wherein X″ᵢⱼ is generated by rounding off the restored residual coefficient X′ᵢⱼ using an equation 3:
X″ᵢⱼ=round(X′ᵢⱼ+0.5) Eq. 3
X″ᵢⱼ=round (X+0.5) Eq. 3 where X″ᵢⱼ is a final restored residual coefficient of a 4×4 unit block.
